(19) United States
(12) Patent Application Publication
(10) Pub. No.: US 2019/0166974 A1
(43) Pub. Date: Jun. 6, 2019

(54) Disposable Portable Pocket Fluid/Floss Dispenser

(71) Applicant: Mark Davidov, Kew Gardens, NY (US)

(72) Inventor: Mark Davidov, Kew Gardens, NY (US)

(21) Appl. No.: 15/917,213

(22) Filed: Mar. 9, 2018

Related U.S. Application Data
(63) Continuation-in-part of application No. 15/832,160, filed on Dec. 5, 2017.

(51) Int. Cl. A45D 34/00; G09B 21/00; A45D 42/00; B65D 25/42; B65D 47/08; A61C 15/04

(52) U.S. Cl. CPC A45D 34/00; G09B 21/003; A61C 15/043; B65D 25/42; B65D 47/0804; A45D 42/00

(57) ABSTRACT

A disposable, portable and compact fluid and floss dispenser that is substantially rectangularly shaped with dispensers for fluid located at each of the four slanted configured corners and a spindle far dispensing floss and a mirror located on the bottom surface of the dispenser housing. In one embodiment two layers or sections are connected together. Nozzles are provided on a housing portion that is adapted to connect preferably by being form fitted onto the container to dispense fluid, drops or foam.

### RELATED APPLICATIONS

The present application is a continuation-in-part of U.S. Ser. No. 15/832,160 filed on Dec. 5, 2017 and U.S. Ser. No. 62/432,234 filed on Dec. 9, 2016 and claims priority thereunder pursuant to 37 USC 120.

### BACKGROUND

### 1. Field

The present invention relates to a disposable portable pocket fluid and floss dispenser. In particular, the present invention relates to a portable compact device for dispensing fluid such as liquid medication, mouthwash, eyedrops, etc. and a dispenser for floss with a mirror located on the bottom surface of the compact device that is thin and be carried in a pocket by a user.

### 2. The Related Art

### SUMMARY

The present invention providing a disposable, portable and compact fluid and floss dispenser that is substantially rectangularly shaped with dispensers for fluid located at each of the four slanted configured corners and a spindle for dispensing floss and a mirror located on the bottom surface of the dispenser housing.

### BRIEF DESCRIPTION OF THE DRAWINGS

FIG. 1 shows a first embodiment with nozzle disposers for fluids a perspective view of the present invention;

FIG. 2A-2B shows the floss spindle of the present invention in which:

FIG. 2A shows the floss spindle in it popped up position for dispensing floss; and

FIG. 2B shows the floss spindle pressed down and locked in place within the dispenser of the present invention;

FIG. 3 is a partially exploded perspective view of the present invention;

FIG. 4A is a perspective view of the present invention wherein the pressure buttons are not depressed;

FIG. 4B is a sectional view of FIG. 4A;

FIG. 5A-5B show the activation mechanism for dispensing fluid or foam though the nozzles of the present invention in which:

FIG. 5A is a perspective view of the present invention wherein the pressure buttons are depressed thereby pressing on the fluid or foam or drops containers of the second layer of the present invention to dispense the fluid or foam through the nozzles;

FIG. 5B illustrates the activation mechanism for dispensing fluid or foam through the nozzles of the present invention;

FIGS. 6a-6B show the frame for the present invention in which:

FIG. 6A is a perspective view of the frame housing and encasing and securely holding the first, second and third layers of the present invention in place; and

FIG. 6B is a top view of FIG. 6A;

FIG. 7 is a partially exploded perspective view showing how the pressure buttons activate the fluid foam or drop containers to dispense through the nozzles and how the floss spindle is engaged and disengaged for dispensing floss;

FIGS. 8A and 8B show the floss spindle engaging mechanism in which:

FIG. 8A shows a top perspective view of the mechanism;

FIG. 8B shows a bottom perspective view of the engagement mechanism;

FIG. 9 shows a fluid nozzle of the present invention;

FIG. 10 shows a spray nozzle of the present invention; and

FIG. 11 shows a bottom view of the third layer the present invention with a mirror thereon;

FIGS. 12-17 show another embodiment of the present invention in which the floss dispenser is on an exterior surface of the container and spray nozzles can be positioned or located so as to spray from any desired and positioned angle to dispense fluid wherein the nozzle is chosen to be mounted from either the side of the housing with the spray nozzles pointed and positioned sideways or downward to dispense fluid and the housing can have any particular shape including but not limited to a rectangular, square, oval, triangular, oval, pyramidal or circular shape

FIG. 12 shows a top and bottom exterior surface of the housing for this second embodiment of the present invention;

FIG. 13 shows a close up of one of the nozzles;

FIG. 14 shows an interior surface of the top and bottom surfaces of the housing with the floss wound inside one of the interior surfaces of the housing and a container that is adapted to be placed inside a hollowed out region of the interior surface of the housing where said container has the nozzles therein;

FIG. 15 shows the top and bottom surfaces of the housing with the floss wound and the container for the nozzles for insertion into a hollowed out region of the interior surface of the housing;

FIG. 16 shows the exterior top surface of the container;

FIG. 17 shows the exterior bottom surface of the container; and

FIG. 18 shows an alternative embodiment for the embodiment of FIG. 12 wherein instead of nozzles, a button located on the housing is pressed which squeezes fluid out of the housing to dispense fluid from an opening on a side of the housing. The button is preferably formed as a section, preferably circular shaped, of a surface of the housing and has a thinner flexible material preferably plastic and preferably polypropylene plastic material which is thinner and more flexible than the remainder of the surface of the housing where the housing is preferably formed of plastic material and preferably polypropylene plastic material. When the button is pressed or squeezed by a user the fluid container within the housing can flow out through one or more openings, apertures, outlets or nozzles including but not limited to the nozzles described in the second embodiment of FIGS. 12-17. The nozzles, outlets, aperture or openings can have removable caps attached to prevent fluid from leaking therefrom when dispensing is not being executed by a user of the present invention.

### DETAILED DESCRIPTION OF THE PREFERRED EMBODIMENTS

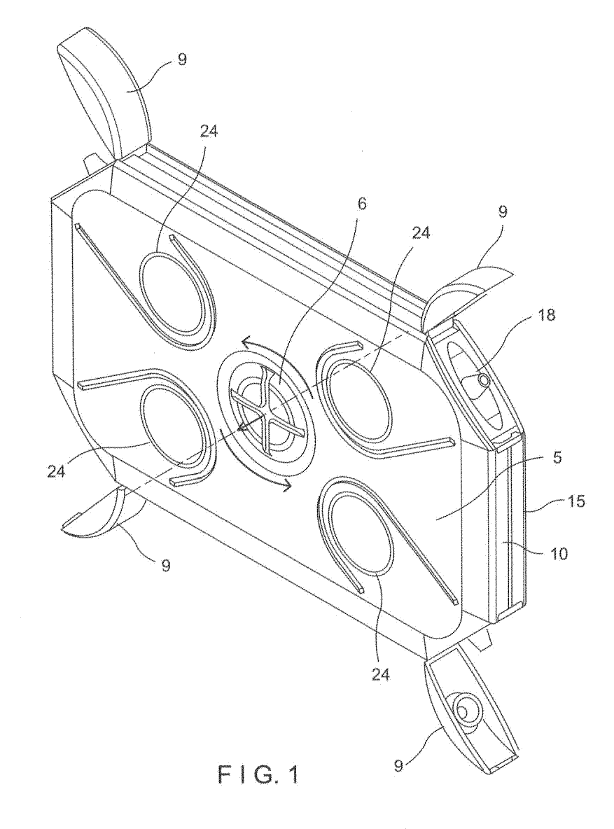

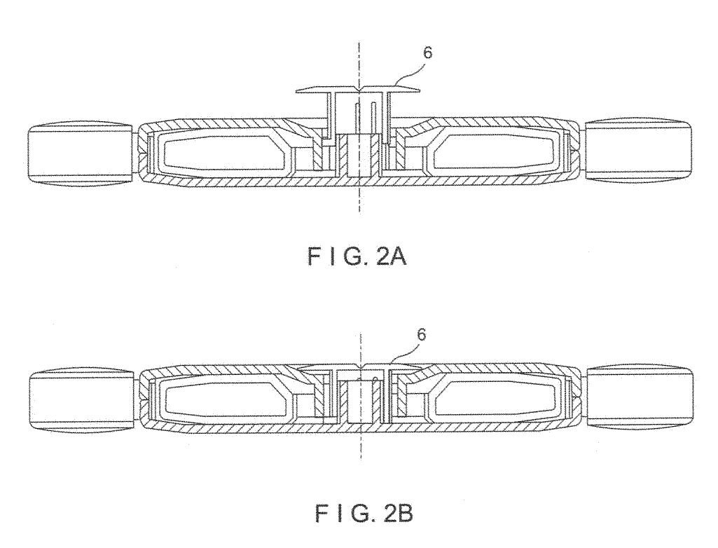

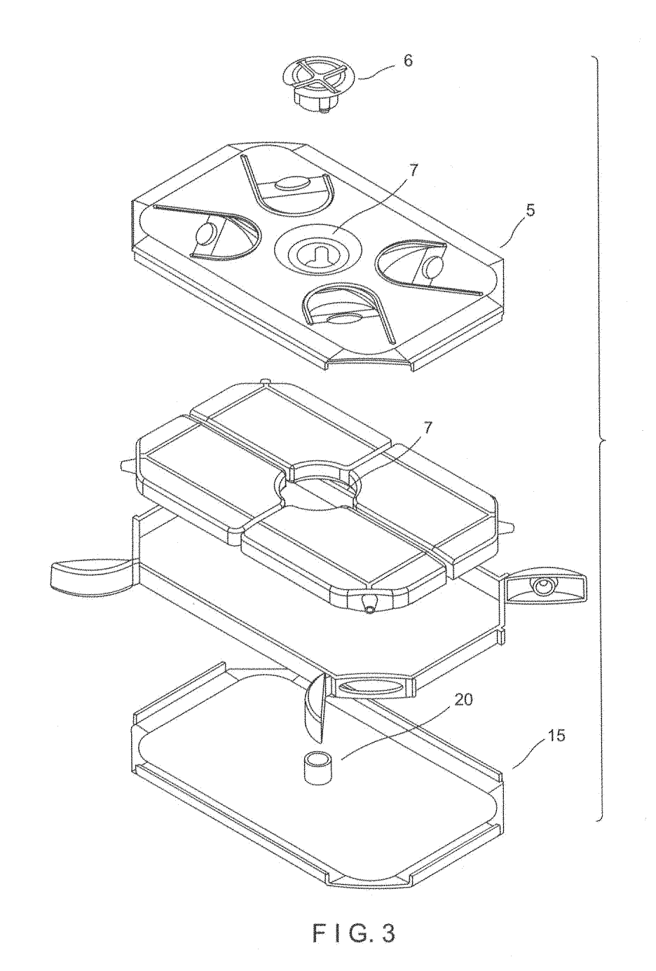

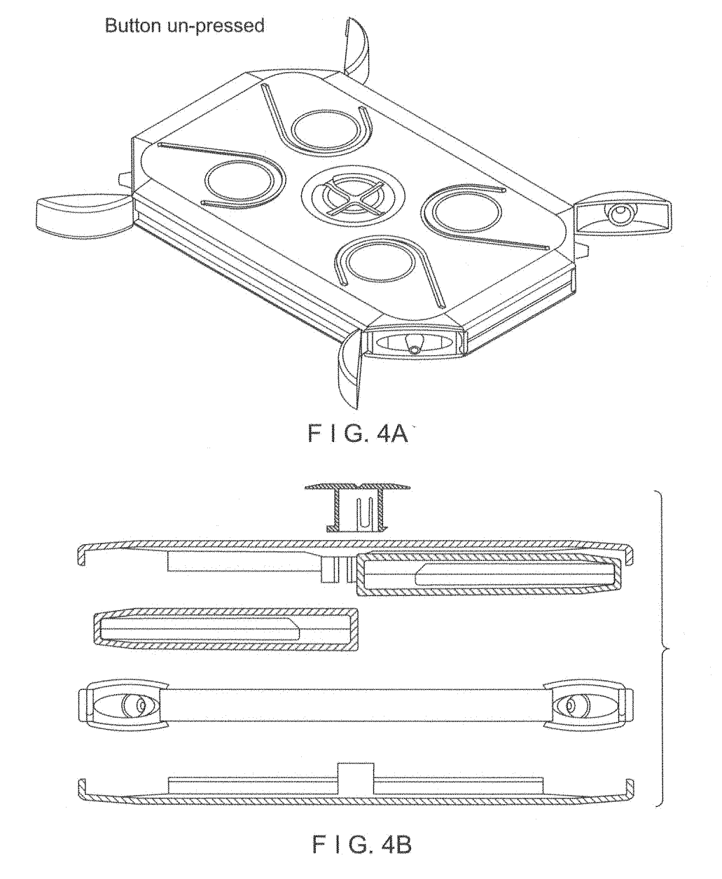

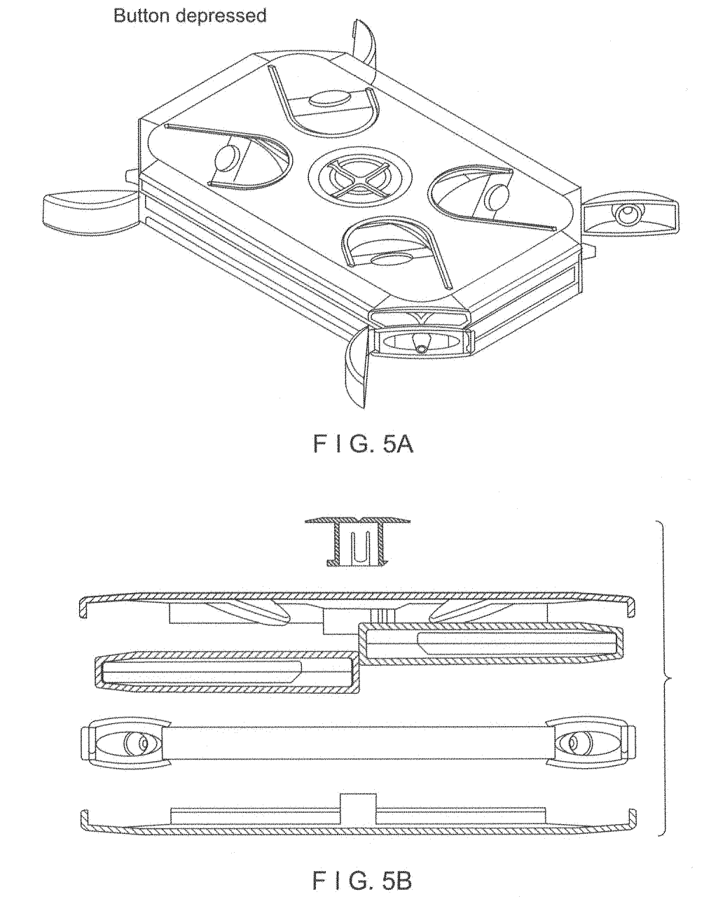

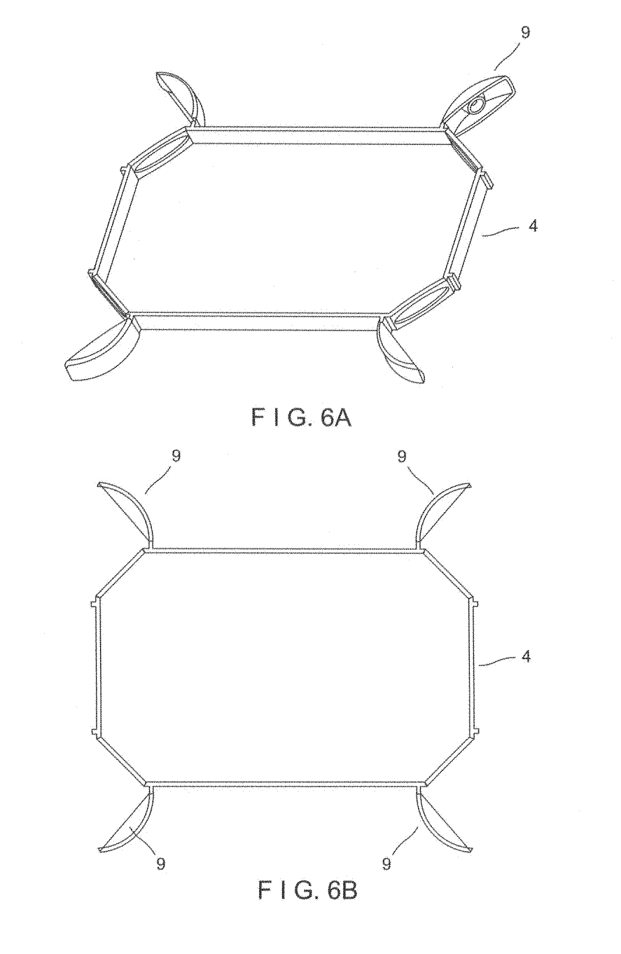

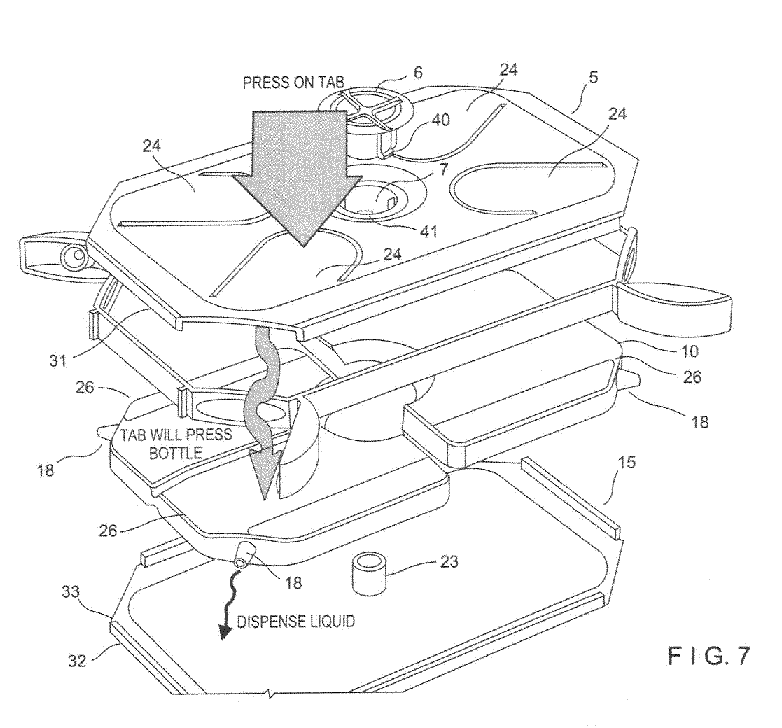

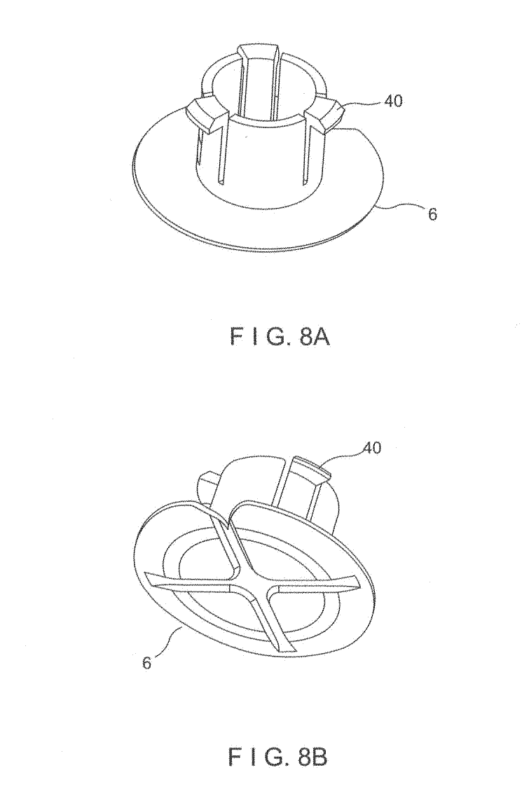

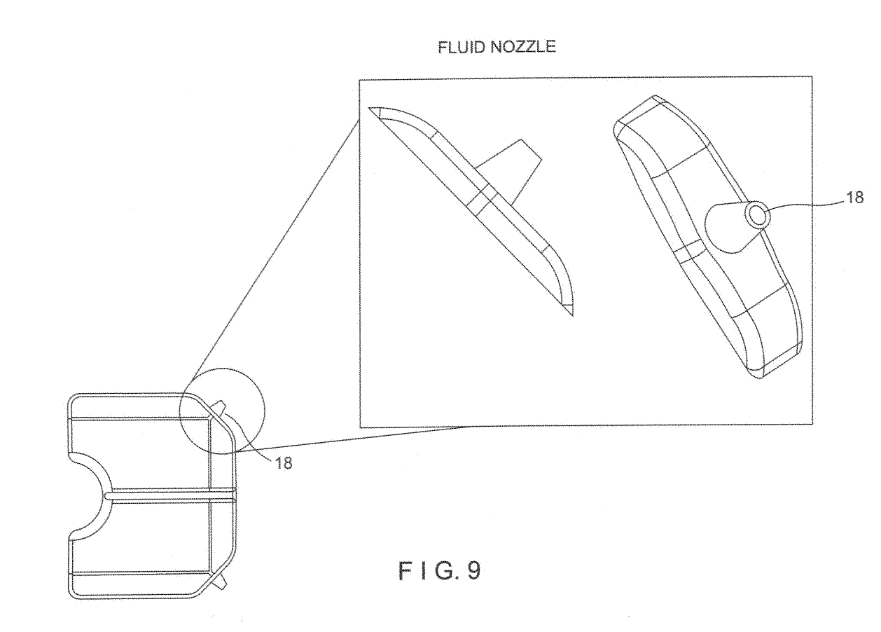

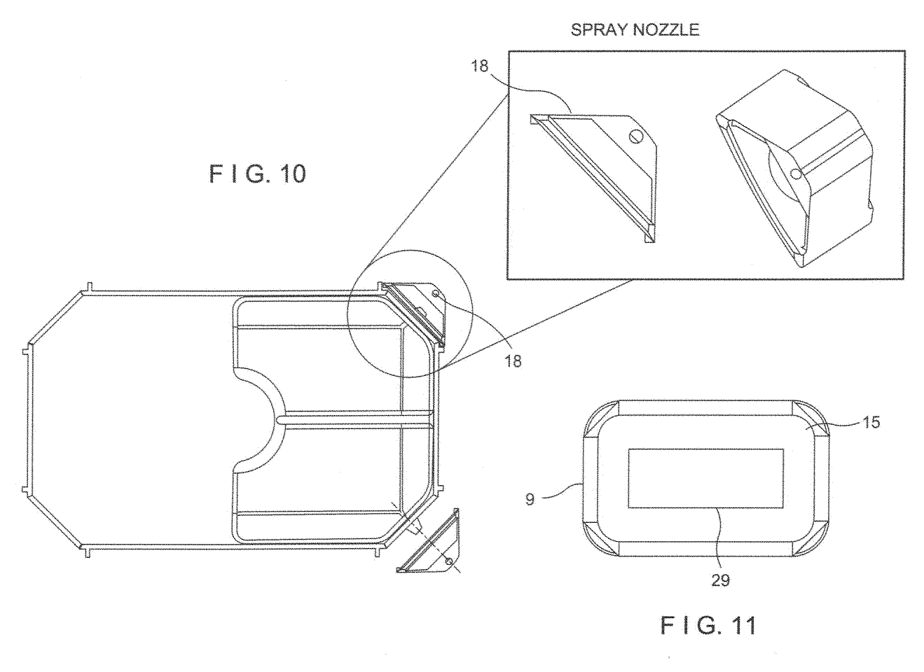

The present invention relates to a portable pocket fluid and floss dispenser suitable for dispensing fluids such as mouthwash, fluid headache medication, hand gels, shampoo, liquid or foam having liquid or foam dispensers or spray dispenser nozzles. Referring now to the drawings of FIGS. 1-2F, FIG. 1 shows an embodiment of the present invention which has three layers or sections 5, 10 and 15 and an outer frame 4 housing and connecting the three layers 5, 10 and 15 together. The three layers 5, 10 and 15 include a top layer 5 having a pop up floss spindle 6 which pops up when pressed and/rotated as shown in FIG. 1. The top layer 5 of the device has a spindle portion 6 underneath onto which floss 26 is wound about the dispenser. As can be seen in the third and bottom layer 15 there is a holder for the pop up spindle mechanism 6 for the floss dispenser and an opening 7 that goes through each of the second layer 10 in order to provide a firm holding connection for the spindle 6 with the holder of the spindle The top layer 5 has an opening with a rim surface 12 and a catch mechanism 13 so that when the spindle 6 is pressed downward and rotated in one direction it will engage the catch mechanism 13 and pop up so a user can dispense floss 26. When the spindle 6 is pressed down and rotated again it will engage the rim 12 moving away from the catch mechanism 13 and stay locked in place so that the top surface of the spindle 6 is flush with the top surface of the top layer 5 of the present invention.

The frame 4 of the present invention is preferably rectangularly shaped and has 4 corners that are slanted or angled in which nozzles are provided on the third layer 15 of the housing 1 to dispense fluid. As shown in FIG. 1 the nozzles 18 can be liquid dispensers. Alternatively as shown in FIG. 2C it can be spray dispensers or alternatively it can be foam dispensers depending on the fluid or foam to be dispensed. It is also possible for the present invention to have a mix of different nozzles 18 of each of those dispensers such as two fluid dispensers, a form dispenser and a spray dispenser including a fluid dispenser can be configured as an eye drop dispenser for dispensing eye drop medication or contact lens fluid. The nozzles 18 can have a cover or lid on them as shown in FIG. 2C. The present invention is preferably manufactured of polypropylene plastic material or else any other suitable alternative plastic material. The 3 layers 5, 10 and 15 shown in FIG. 1 can snap together assemble to a relatively thin container or housing 1 for dispensing fluids that can he disposable, portable and fit into a pocket of a user. The frame 4 is fixedly connected to the three layers 5, 10 and 15 preferably with adhesive material making the present invention a disposable device.

The size of the container or housing 1 is preferably the size of a credit card. Alternative plastic materials for the container include polycarbonate/ABS polyester thermoplastic polyphenylene oxide, poly pehenylne sulfide polystyrene and also polystyrene high impact in addition styrene acrylonitrile can be used. In FIG. 1 the first top layer 5 has the spindle 6 thereon. There are also squeezable plastic pressure flaps that bend downward to put pressure on a respective one of the a fluid or foam container in the second layer of the present invention to disuse the fluid or foam therein through its respective nozzle 18 as shown in FIG. 1 thereby pressing the dispensed fluid or foam from the nozzles 18. Alternatively each nozzle 18 can have an activation button on it (not shown) which can be manually pressed by a user to dispense the fluid, foam or spray through its respective nozzle 18.

The second layer 10 underneath the top layer 5 contains the nozzles 18 on each of the 4 slanted corners, the frame 4 contains a covering for the nozzles 18 on each of the 4 corners where the covering can he manufactured as a hinge mechanism such as but not limited to a living hinge to open or close out by simply flipping it open or close and a bottom layer which contains the holder for the spindle 6. Underneath the bottom of the surface of the bottom layer 15 as shown in FIG. 2F is a mirror 29 for the user to use when flossing his teeth or combing his hair, etc. There is an overleaf on the top layer 5 which engages with the overleaf of the bottom layer 15 the overleaf is to he ultrasonically welded to the lop layer 5 and will fit inside the recess and will close tightly with the bottom layer to keep the entire container in place. Preferably the second layer 10 would be made of a high density polyethylene plastic material and the layer underneath that would be made of a polypropolene material. In operation the present invention works as follows. A user would take the assembled version of the present invention and dispense fluid by pressing on one of the four plastic pressure points after flipping open the cap on the corresponding nozzle 18 to dispense fluid. This may be either one of the aforementioned fluids or foams noted above. These user may also press on the floss dispenser holder at the top surface 5 to release the pop up the spindle 6 and release floss 26 as can be seen there is a detachable engagement between the spindle 6 and a mechanism 13 for catching it in place as shown in the top portion of FIG. 1 of the drawings. In this way a user can carry with him medication or any fluid or foam toiletry required for cosmetic grooming in an efficient and portable manner.

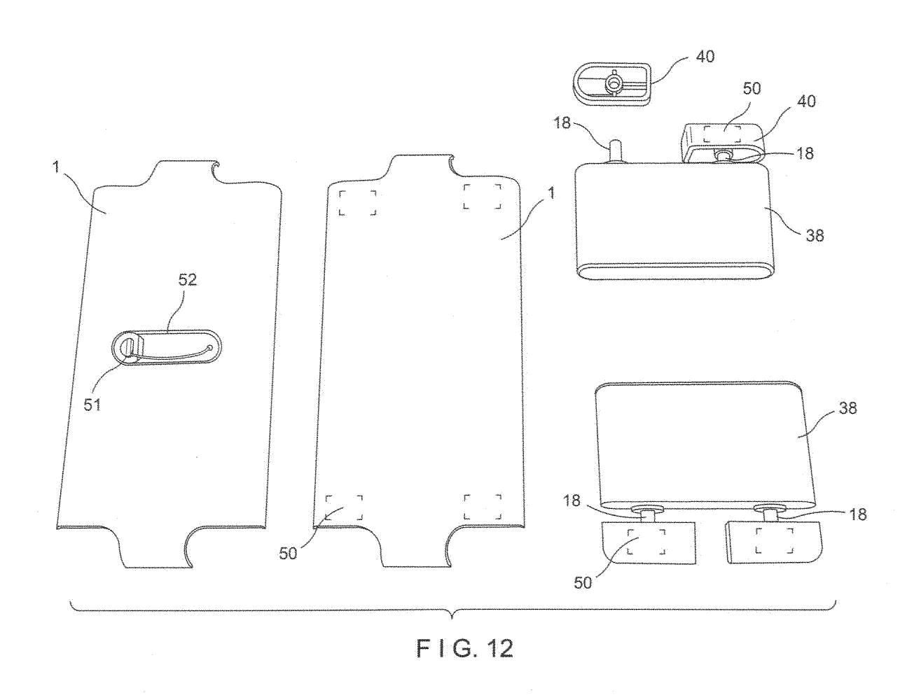

A mirror 29 is preferably located and affixed preferably by adhesive material to a bottom surface of the third layer 15 for use by a user as shown in FIG. 11.
FIGS. 12-17 show another embodiment of the present invention in which the floss dispenser is placed on an exterior surface of the housing 1 and spray nozzles 18 are located and positioned to be sprayed from any chosen desired angle location from either a side of the housing 1 and the spray nozzles 18 can be positioned at a desired angle to point sideways or downward to dispense fluid and the housing 1 can have any particular geometrical shape including rectangular, square, triangular, circular, parabolic, pyramidal, oval, elliptical wherein:

FIG 12 shows the second embodiment of the present invention with a rectangular shape and spray nozzles 18 that can be located at any desired position to be sprayed from any desired angle from either the side of the housing 1 and the spray nozzles 18 can be located at any desired angle to point it either sideways or downward to dispense fluid. FIG 12 shows the second embodiment of the present invention with a rectangular shape and spray nozzles 18 that can be located at any desired position to be sprayed from any desired angle from either the side of the housing 1 and the spray nozzles 18 can be located at any desired angle to point it either sideways or downward to dispense fluid. A cutting edge 51 as shown in FIG. 12, preferably made of metallic material and bounded preferably by adhesive material or compressively placed on an edge of the floss dispenser 52, is provided on an edge of the floss dispenser for cutting the floss piece off when dispensed from the floss dispenser 52 mounted on the edge of the floss dispenser 52.

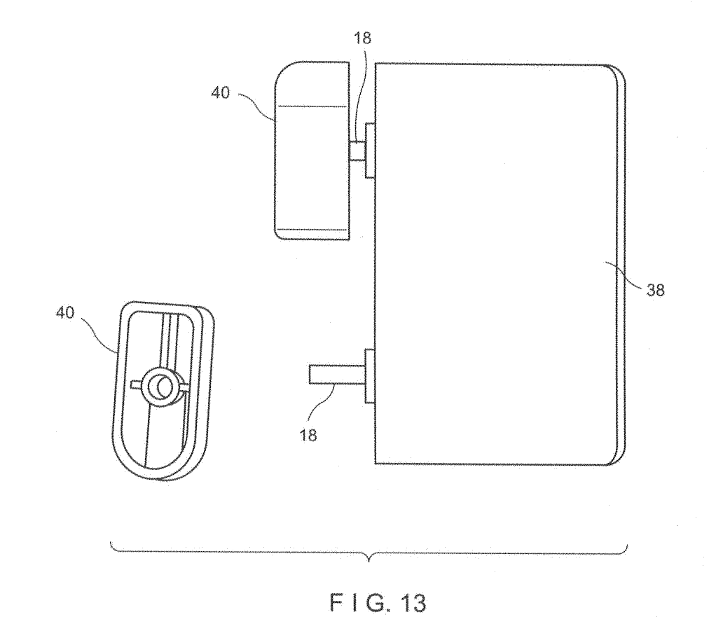

FIG 13. Shows the floss dispenser on an exterior surface of the housing 1 and the spray nozzles 18.

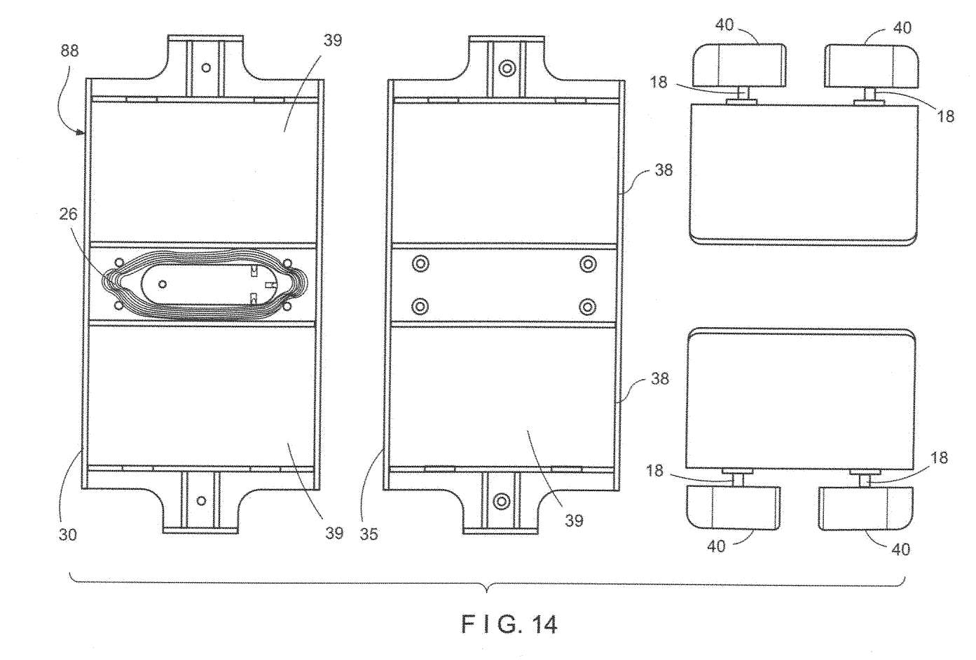

FIG. 14 shows an interior surface of the top 30 and bottom 35 surfaces of the housing 1 with the floss 26 wound inside one of the interior surfaces of the housing 1 and one or more containers and preferably two containers 38, as shown, that are adapted to be placed inside one or more and preferably two hollowed out regions within the interior surfaces of the housing 1 wherein said containers have the nozzles 18 therein which protrude outward from portions of the of the housing 1, preferably the side surface areas when the containers 38 are inserted into the hollowed out regions 39 of the interior surfaces of the housing 1. Caps are provided for placement on top of the nozzles 18 to prevent leaking of fluid when the dispenser is not in use for dispensing fluid. FIG. 14 shows the floss dispenser which is mounted onto an exterior surface, top 30 or bottom 35 of the housing 1.

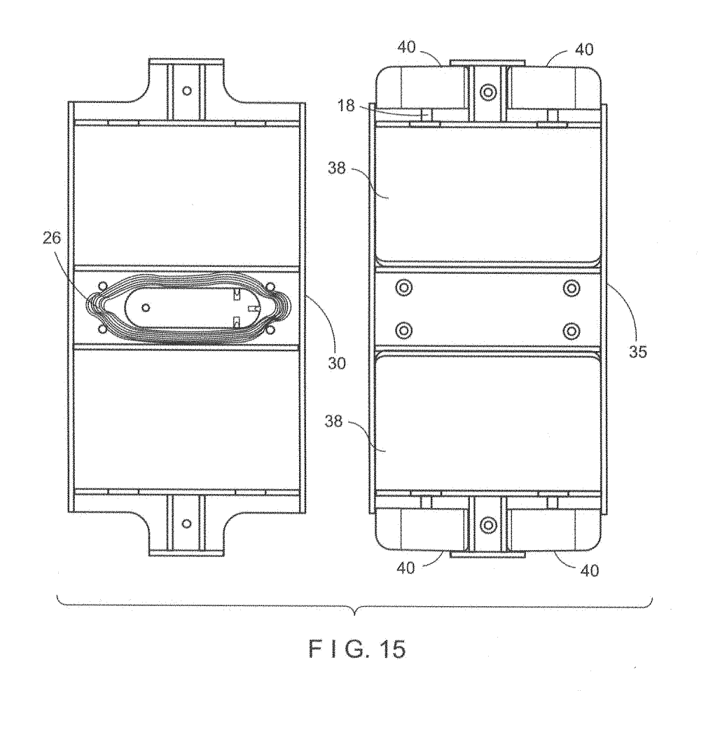

FIG. 15 shows the top 30 and bottom 35 surfaces of the housing 1 with the floss 26 wound and the containers 1 for the nozzles for insertion into the hollowed out regions 39 within the interior surfaces of the housing 1.

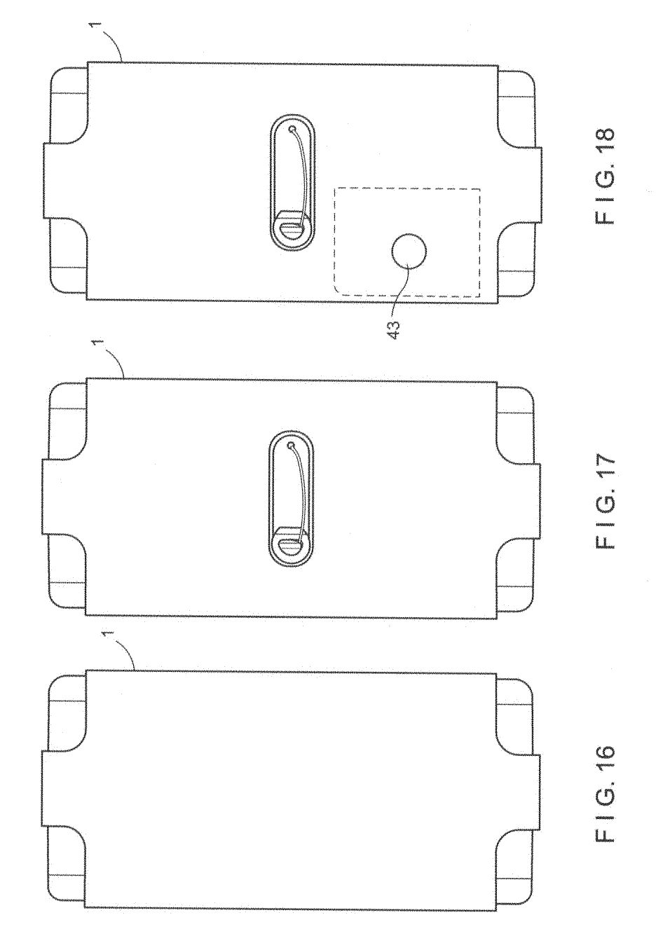

FIG. 16 shows the exterior top surface 30a of the containers 38.

FIG. 17 shows the exterior bottom surface 30b of the container 38.

FIG. 18 shows an alternative or third embodiment for the embodiment of FIG. 12 where the only difference is that instead of nozzles 18 within the containers 38 for dispensing fluid, one or more button 43s, preferably formed of and located on an exterior surface the housing is pressed or squeezed which squeezes fluid out of the housing to dispense fluid from an opening on a side of the housing similar to a squeeze bottle when pressed pushing fluid out of an opening of the bottle, is preferably formed of plastic material and preferably polypropylene plastic material The one or more buttons 43 are located on an exterior surface of said housing 1 which when pressed squeezes fluid out of an opening of a side of said housing to dispense said fluid wherein said one or more buttons 43 are preferably formed as a section, preferably circular shaped, of a surface of the housing and has a thinner flexible material preferably plastic and preferably polypropylene plastic material which is thinner and more flexible than the remainder of the surface of the housing wherein the housing is preferably formed of plastic material and preferably polypropylene plastic material.

In this embodiment, as with the previous embodiment of the present invention, a mirror 29 can be mounted preferably on the bottom exterior surface of the housing. In addition Braille instructions 50, as shown in FIG. 12, can be located preferably next to the nozzle sprays 18 or the one or more buttons 43 that is pressed to release the nozzle spray fluid wherein the Braille instructions 50 indicate the liquid stored for dispensing by the nozzles.

While presently preferred embodiments have been described for purposes of the disclosure, those skilled in the art can make numerous changes in the arrangement of method steps. Such changes are encompassed within the spirit of the invention as defined by the appended claims.

What is claimed:

1. A disposable portable pocket fluid and floss dispenser suitable for dispensing fluids, drops, and foam comprising:
two layers or sections, a top layer and a bottom layer, form a housing for said dispenser and are adapted to be connected together;
said top layer or said bottom layer has on its respective exterior surface a floss spindle which, said spindle portion having floss is wound about on an interior surface of said top or said bottom layer for dispensing by a user;
Spray nozzles are located on a housing portion that is adapted to be connected to said container to dispense fluid, drops or spray, said
spray nozzles are located and/or positioned to spray from any desired positioned angle from either a side of the housing mi the spray nozzles are positioned to be angled to either point said nozzles sideways or downward to dispense fluid

2. The dispenser according to claim 1 wherein the container can have any particular geometric including any one of a rectangular, square triangular, circular, oval, elliptical, parabolic, or pyramidal shape.

3. The dispenser according to claim 1 wherein said nozzles include at least one fluid nozzle.

4. The dispenser according to claim 1 wherein said nozzles include at least one foam nozzle.

5. The dispenser according to claim 1 wherein said nozzles include at least one spray nozzle.

6. The dispenser according to claim 1 wherein said nozzles include at least one eye drop or nozzle.

7. The dispenser according to claim 1 wherein said nozzles include at least one nasal drop nozzle.

8. The dispenser according to claim 1 wherein said nozzles include at least one fluid nozzle, one spray nozzle, one foam nozzle and one eye drop or nasal drop nozzle.

9. The dispenser according to claim 1 wherein each said nozzle has an activation button which can be manually pressed to dispense fluid, drops and/or foam there through.

10. The dispenser according to claim 1 wherein said dispenser is made of polypropylene plastic material.

11. The dispenser according to claim 1 wherein said frame is rectangularly shaped.

12. The dispenser according to claim 1 wherein said dispenser is approximately the size of a credit card.

13. The dispenser according to claim 1 further including at least one button that is pressed to release the nozzle spray fluid from on or more of said nozzles where the Braille instructions indicate the liquid stored for dispensing by the nozzles.

14. The dispenser according to claim 13 wherein said button when releases either a spring activated or level controlled mechanism for said nozzles to dispense fluid.

15. The dispenser according to claim 13 wherein Braille instructions are located either next to the nozzle sprays

16. The dispenser according to claim 1 wherein said two layers or sections are sonically welded together after being assembled to be connected together.

17. The dispenser according to claim 1 wherein instead of nozzles and a container having said nozzles therein, one or more buttons are located on an exterior surface of said hosing which when pressed squeezes fluid out of an opening of a side of said hosing to dispense said fluid wherein said one or more buttons are preferably formed as a section, preferably circular shaped, of a surface of the housing and has a thinner flexible material preferably plastic and preferably polypropylene plastic material which is thinner and more flexible than the remainder of the surface of the housing wherein the housing is preferably formed of plastic material and preferably polypropylene plastic material.

18. The dispenser according to claim 17 wherein Braille instructions indicate the liquid stored for dispensing by said one or more buttons being pressed.

19. The dispenser according to claim 1 wherein instead of two layer of said container three layers or sections and an outer frame housing and connecting the three layers together, said three layers including a top layer
a third and bottom layer wherein either said top layer or said bottom layer has on its respective exterior surface having a floss spindle which, said spindle portion having floss is wound about for dispensing by a user;
said floss dispenser instead of being located on an exterior surface of said housing has said top layer having a pop up floss spindle which pops up when pressed and rotated, said spindle portion having floss is wound about for dispensing by a user; said third and bottom layer has a holder for the pop up spindle mechanism for the floss dispenser and an opening that goes through each of the second layer in order to provide a firm holding connection for the spindle with the holder of the spindle;
and wherein said top layer has an opening with a rim surface and a catch mechanism so that when the spindle is pressed downward and rotated in one direction it will engage the catch mechanism and pop up so a user can dispense floss and when the spindle is pressed down and rotated again it will engage the rim moving away from the catch mechanism and stay locked in place so that the top surface of the spindle is flush with the top surface of the top layer; and
flaps are located on said top layer and in registration with fluid or foam containers to locate d on said second level so that when each flap is pressed downward it exerts pressure on tis respective fluid or foam container to dispense fluid or foam form a nozzle
and said frame is shaped with 4 corners that are slanted or angled to provide covers or hinged covers for nozzles located in corners of said second level through which said fluid, drops or foam can be dispensed; and
nozzles are provided on each of the corners of the third layer of the housing to dispense fluid, drops or foam.

20. The dispenser according to claim 1 wherein the housing is preferably formed of plastic material and preferably polypropylene plastic material.
